(19) United States
(12) Patent Application Publication
(10) Pub. No.: US 2003/0042701 A1
(43) Pub. Date: Mar. 6, 2003

(54) Rear-wheel steering structure of light bicycle

(76) Inventors: Tseng Hsien Chen, I Lan Hsien (TW); Tsuan Hung Chen, I Lan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/942,703

(22) Filed: Aug. 31, 2001

(51) Int. Cl. B62M 3/00; B62K 1/00

(52) U.S. Cl. 280/270; 280/263

(57) ABSTRACT

The present invention provides a rear-wheel steering structure of light bicycle. The rear-wheel steering structure comprises a transmission link, a steering link, a rotation axis, and a hub base. One end of the transmission link is pivotally joined with the steering link. The other end of the steering link is pivotally joined with one end of the rotation axis. The upper end of the hub base is pivotally joined with one end of the rotation axis. The other end of the hub base is pivotally joined on a small wheel. Through the action of the transmission link, the steering link is led to turn about, and the rotation axis and the hub base are simultaneously driven to double the turned angle of said small wheel, hence shrinking the space of return, enhancing the flexibility of steering angle, and achieve convenience in ride.

### FIELD OF THE INVENTION

The present invention relates to a rear-wheel steering structure of light bicycle and, more particularly, to a novel rear-wheel steering structure getting rid of the restriction of design of a conventional bicycle (e.g., a light bicycle or a skateboard bicycle) and capable of letting front and rear wheels thereof synchronously turn in the opposite directions to shrink the space of return and to enhance the flexibility of steering angle.

### BACKGROUND OF THE INVENTION

FIG. 1 shows a steering structure of a prior art light bicycle. The light bicycle 10 comprises a control handle 101, a cushion 102, a frame 103, a large wheel 104, two pedals 105, and a small wheel 106. When one rides the light bicycle 10, he can use the control handle 101 on the frame 103 to control the direction, and step on the two pedals 105 to drive the large wheel 104 and the small wheel 106, thereby leading the light bicycle 10 to move forwards. The cushion 102 is used to provide comfort for the rider.

However, in the above light bicycle 10, because the distance between the large wheel 104 and the small wheel 106 is too short, a larger space is required so that the small wheel 106 can be led to turn about when the direction of the light bicycle 10 is to be changed, resulting in trouble and inconvenience of ride.

Accordingly, the steering structure of the above light bicycle has inconvenience and drawbacks in practical use. The present invention aims to resolve the problems in the prior art.

### SUMMARY OF THE INVENTION

The primary object of the present invention is to provide a rear-wheel steering structure of light bicycle applicable to any kind of bicycle (e.g. a light bicycle or a skateboard bicycle) and capable of letting front and rear wheels thereof synchronously turn in the opposite directions to double the turned angle, hence shrinking the space of return, enhancing the flexibility of steering angle, and achieving convenience in ride.

To achieve the above object, the present invention provides a rear-wheel steering structure of light bicycle. The rear-wheel steering structure comprises a transmission link, a steering link, a rotation axis, and a hub base. One end of the transmission link is pivotally joined on a front fork portion of the bicycle. The other end of the transmission link is pivotally joined with one end of the steering link. The other end of the steering link is pivotally joined at the upper end of the rotation axis. The rotation axis is inserted in a bushing. A plurality of rotation bearing is disposed in the bushing to facilitate rotation of the rotation axis. The end edge near the upper end of the rotation axis is joined with a shock absorber on the small wheel. The lower end of the rotation axis is pivotally joined with one end of the hub base. The other end of the hub base is pivotally joined on the small wheel.

The various objects and advantages of the present invention will be more readily understood from the following detailed description when read in conjunction with the appended drawing, in which:

### BRIEF DESCRIPTION OF THE DRAWINGS

FIG. 1 is a plan diagram of a prior art light bicycle;

FIG. 2 is a perspective view of the present invention;

FIG. 3 is a side view of the present invention;

FIG. 4 is a top view of the present invention;

FIG. 5 is an action side view of the present invention; and

FIG. 6 is another action side view of the present invention.

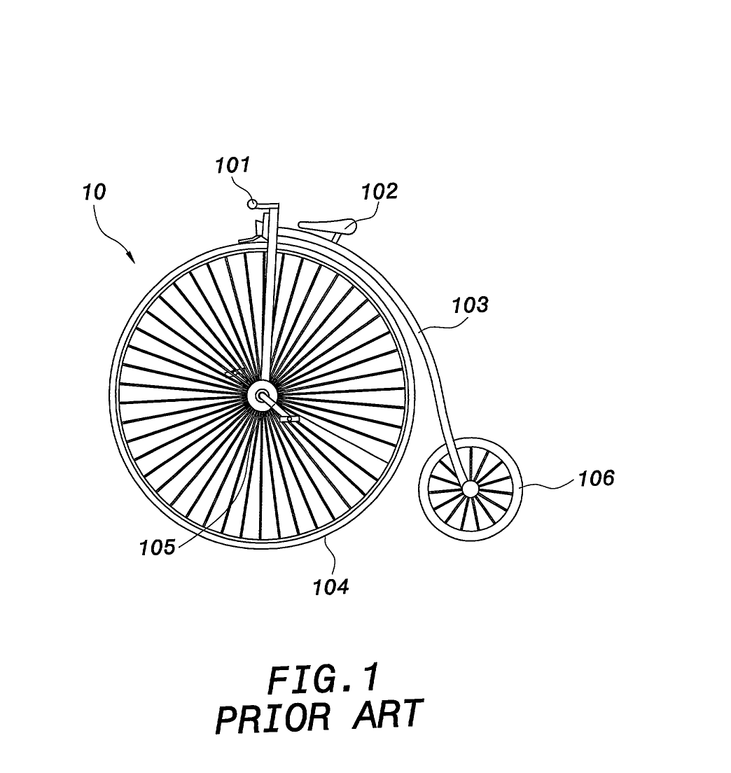

### DETAILED DESCRIPTION OF THE PREFERRED EMBODIMENTS

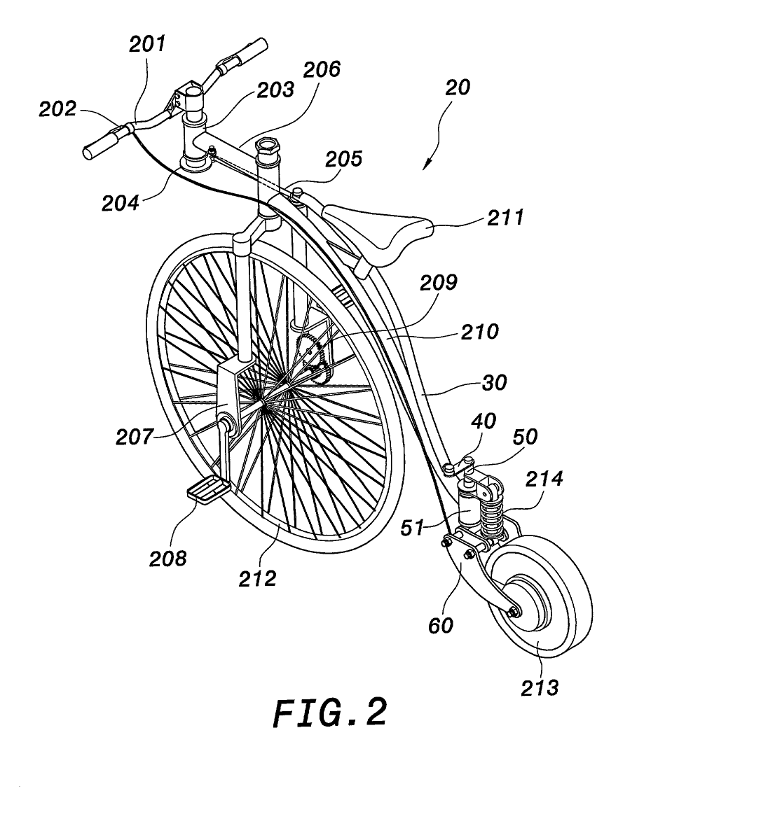

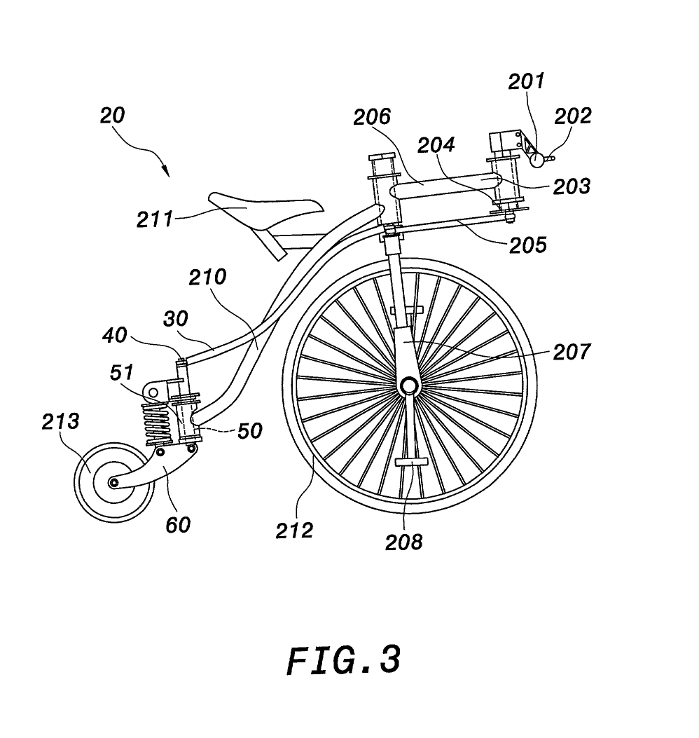

As shown in FIGS. 2 and 3, the present invention relates to a rear-wheel steering structure of light bicycle and, more particularly, to a novel rear-wheel steering structure getting rid of the restriction of design of a conventional bicycle (e.g., a light bicycle or a skateboard bicycle) and capable of letting front and rear wheels thereof synchronously turn in the opposite directions to shrink the space of return and to enhance the flexibility of steering angle. A light bicycle 20 comprises a control handle 201, two braking units 202, a fixing rod 203, a pivotal portion 204, a link 205, a transversal rod 206, a front fork portion 207, two pedals 208, a plurality of gears 209 having different gear ratios and meshing each other, a frame 210, a cushion 211, a large wheel 212, a small wheel 213, and a shock absorber 214.

The control handle 201 for controlling direction and the two braking units 202 are disposed on the light bicycle 20. The control handle 201 is inserted and joined at the front end of the fixing rod 203. The pivotal portion 204 is disposed at the bottom of the front end of the fixing rod 203. The pivotal portion 204 is pivotally joined with one end of the link 205. The fixing rod 203 can be joined on the transversal rod 206. The transversal rod 206 and one end of the link 205 are joined with the front fork portion 207.

The two pedals 208 are pivotally joined at bottom ends of two sides of the front fork portion 207. When the two pedals 208 are stepped on, the gears 209 having different gear ratios and meshing each other can turn. The front fork portion 207 is also joined with the frame 210 and the large wheel 212. The cushion 211 and the shock absorber 214 can be joined on the frame 210. The cushion 211 is used to provide comfort for a rider. The shock absorber 214 can be used to effectively reduce vibration generated by the small wheel 213. Because the above structures are the same as those applicable to the prior art and thus will not be further described.

As shown in FIGS. 2, 3, and 4, a rear-wheel steering structure of light bicycle comprises a transmission link 30, a steering link 40, a rotation axis 50, and a hub base 60.

One end of the transmission link 30 is pivotally joined with the front fork portion 207, as shown in FIG. 3. The other end of the transmission link 30 is pivotally joined with one end of the steering link 40. The other end of the steering link 40 is pivotally joined at the upper end of the rotation axis 50. The rotation axis is inserted in a bushing 51. The bushing 51 can protect the rotation axis 50 so that the rotation axis can rotate smoothly. A plurality of rotation bearings (not shown) are disposed in the bushing 51 to facilitate rotation of the rotation axis 50. The end edge near the upper end of the rotation axis 50 is joined with the shock absorber 214 to reduce vibration generated by the small wheel 213. The lower end of the bushing 51 is joined with the hub base 60. The other end of the hub base 60 is pivotally joined at two sides of the small wheel 213. The shock absorber 213 can effectively reduce vibration of the small wheel to provide comfort for a rider.

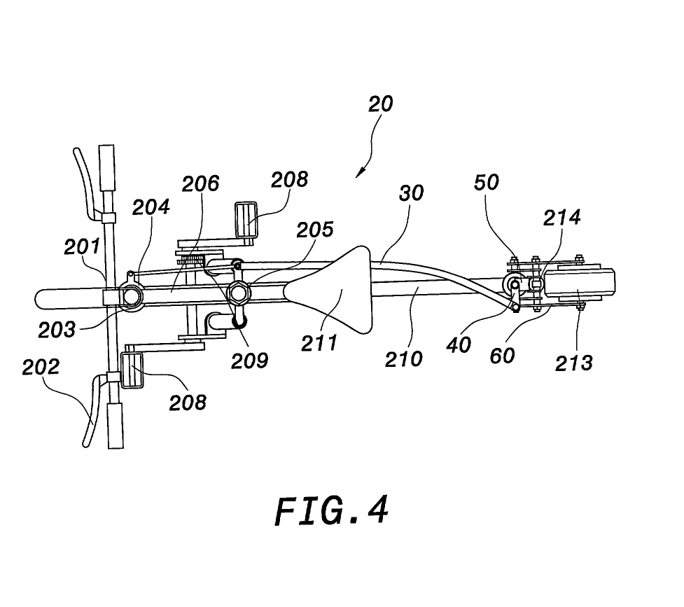

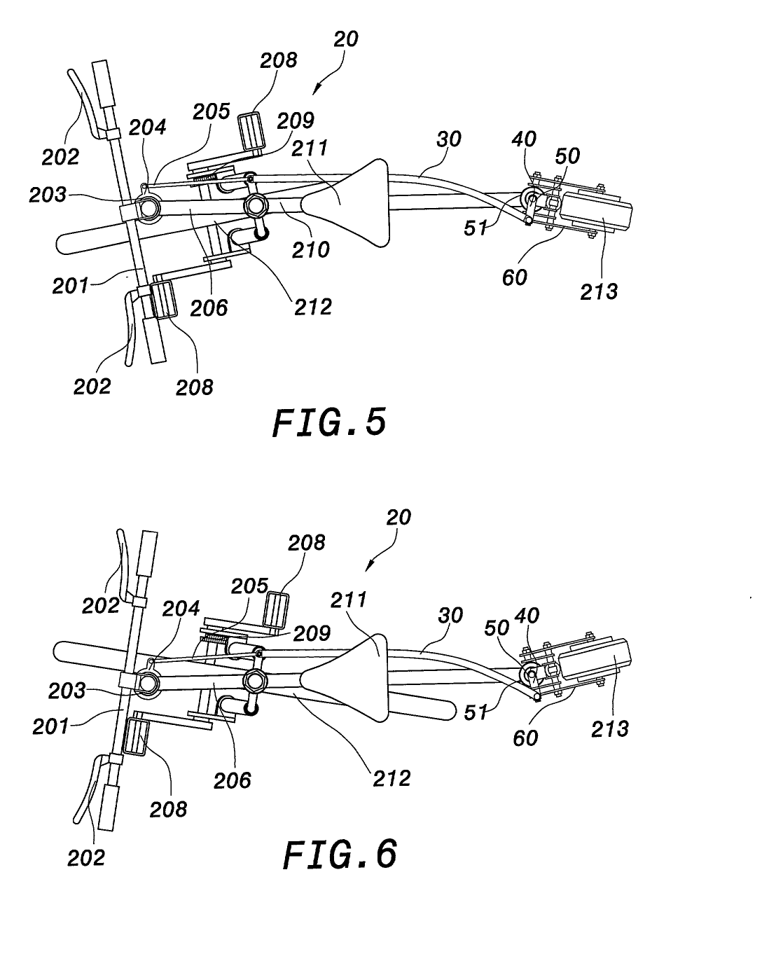

As shown in FIGS. 4, 5, and 6, when a rider turns the control handle 201 of the light bicycle 20, because the lower end of the control handle 201 is pivotally joined with the pivotal portion 204 and the link 205, the link 205 will be turned by the control handle 201 to drive the front fork portion 207 and the large wheel 212 to turn about. The transmission link 30 pivotally joined with the front fork portion 207 is then driven to act. Through the action of the transmission link 30, the steering link 40 can be led to turn about, and the rotation axis 50 and the hub base 60 are simultaneously driven to compel the small wheel 213 to reduce the steering angle, hence shrinking the space of return, enhancing the flexibility of steering angle, and achieving convenience in ride. Therefore, the present invention can get rid of the restriction of design of a conventional bicycle, enhance the flexibility of steering angle of the large wheel 212 and the small wheel 213, and achieve convenience in ride.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A rear-wheel steering structure of a light bicycle, said light bicycle comprising a control handle, a pivotal portion, a link, a transversal rod, a front fork portion, a frame, a large wheel, a small wheel, and a shock absorber, said front fork portion being pivotally joined with a transmission link, one end of said transmission link being pivotally joined with one end of a steering link, the other end of said steering link being pivotally joined at an upper end of a rotation axis, a lower end of said rotation axis being pivotally joined with a hub base, one end of said hub base being pivotally joined on said small wheel;
whereby when said control handle is turned, said transmission link is driven to act, said steering link is led to turn about, and said rotation axis and said hub base are simultaneously driven to double the turned angle of said small wheel, thereby shrinking the space of return and enhancing the flexibility of steering angle.

2. The rear-wheel steering structure of a light bicycle as claimed in claim 1, wherein said rotation axis is inserted in a bushing used for protecting said rotation axis so that said rotation axis can rotate smoothly.

3. The rear-wheel steering structure of a light bicycle as claimed in claim 2, wherein a plurality of rotation bearing is disposed in said bushing.
